(19) United States
(12) Patent Application Publication
(10) Pub. No.: US 2019/0347902 A1
(43) Pub. Date: Nov. 14, 2019

(54) GAMING DEVICE AND PRIZE POOL SWITCH CONTROL SYSTEM THEREOF

(71) Applicant: JUMBO TECHNOLOGY CO., LTD., Taichung (TW)

(72) Inventors: SHUN-TSUNG HSU, Taichung (TW); TSUNG-YU HSU, Taichung (TW); CHANG-YI WANG, Taichung (TW); CHIA-CHING FU, Taichung (TW)

(21) Appl. No.: 15/973,891

(22) Filed: May 8, 2018

(51) Int. Cl. G07F 17/32

(52) U.S. Cl. CPC G07F 17/3258; G07F 17/3223; G07F 17/3211

(57) ABSTRACT

A gaining device includes a prize pool switch control system, which includes an activation threshold calculating element and a control computing unit. The activation threshold calculating element generates at least one activation threshold according to a betting selection of a player and a designated computation method. The control computing unit performs a procedure of: a) capturing the at least one activation threshold and a plurality of prize money values of a prize money server device; b) comparing the prize money values with the at least one activation threshold, and generating an activation signal when at least one of the prize money values corresponds to the at least one activation signal; and c) transmitting the activation signal to the prize money server device to cause a prize money award of the prize money value corresponding to the at least one activation threshold to be in a triggerable state.

### FIELD OF THE INVENTION

The present invention relates to a prize pool, and particularly to a prize pool switch control system.

### BACKGROUND OF THE INVENTION

Gaining machines, requiring no dealers and having minimal possibilities for human cheating as well as low manufacturing and management costs, are suitable for many types of games including slot machines, poker games, Sic Po games and roulette games. Therefore, game machines are extremely popular among players and gaining service providers. To boost the sense of excitement and give players a sense of winning big, common gaining machines are designed with a prize money server device (commonly referred to as a prize pool). Each time a player places a bet, a fixed ratio is allotted from the bet and accumulated towards the prize pool. When the prize pool or the game satisfies a predetermined condition, the player may be rewarded with the prize money in the prize pool. Thus, players may stay attracted to the ever-increasing prize money in the prize pool, and continue playing the gaining machines.

To increase the number of times of winning prize money in order to attract players to play, prize money in a prize pool is designed in hierarchies. That is, a prize pool may have a plurality of prize money awards, e.g., mini, minor, major and grand prizes, which may have different start-up prize money values and correspond to different prize money values that are independently accumulated. Meanwhile, whether prize money can be awarded or whether qualification for entering a prize money game is calculated. Further, the prize money of the prize pool may be jointly accumulated by multiple gaining machines, such that there may be multiple players eligible at the same time to opportunities for winning the prize money. These players need to go through additional prize money games before the player eventually winning the prize money can be determined.

However, for high rollers placing large betting amounts, if the amount of prize money won during the process of the prize money game is smaller than a payout value won from a bet game result during a main game, or one cannot become a final winner after having competed with other players, these high rollers may feel that the prize money game is not worthy of playing at all. That is to say, high rollers in this case may give up the opportunity of winning the prize money, because extra time is needed to play such addition prize money games and the final reward may not meet expectations, or the prize money may be the minimum value of the prize money even if the prize money can be directly obtained. Further, the minimum amount of the prize money may be less than a payout value that can be frequently won during the process of the main game, thus affecting playing rhythms of high rollers and undesirably affecting the playing interest of these high rollers.

### SUMMARY OF THE INVENTION

It is an object of the present invention to disclose a gaining device and a prize pool switch control system thereof. A betting amount of a player is first determined, and a prize money award that is looked forward to by the player having placed such betting amount is activated while small prize money awards are not revealed, thus keeping prize money awards not looked forward to by player deactivated and maintaining the playing rhythm of the player without affecting the playing interest of the player.

To achieve the above object, the present invention provides a prize pool switch control system, which is connected to a gaining device and a prize money server device. The gaining device includes a process computing unit, a betting interface and a game display interface. The process computing unit generates a plurality of game results. The betting interface is operable by a player to generate a betting selection. The game display interface displays the game results. The prize money server device stores a plurality of prize money values corresponding to the plurality of prize money awards. The prize pool switch control system includes an activation threshold calculating element and a control computing unit. The activation threshold calculating element captures the betting selection placed by the player on the betting interface, and generates at least one activation threshold according to a designated computation method. The control computing unit performs a following determination procedure of:

a) capturing the at least one activation threshold and the prize money values;

b) comparing the prize money values with the at least one activation threshold, and generating an activation signal when at least one of the prize money values corresponds to the at least one activation threshold; and

c) transmitting the activation signal to the prize money server device to cause the prize money award of the prize money value corresponding to the at least one activation threshold to be in a triggerable state.

The present invention further provides a gaining device and a prize pool switch control system thereof. The gaining device is connected to a prize money server device, which stores a plurality of prize money values corresponding to a plurality of prize money awards. The gaining device includes a process computing unit, a betting interface, a game display interface and a prize pool switch control system. The process computing unit generates a plurality of game results. The betting interface is operable by a user to generate a betting selection. The game display interface displays the game results.

The prize pool switch control system includes an activation threshold calculating element and a control computing unit. The activation threshold calculating element captures the betting selection placed by the player on the betting interface, and generates at least one activation threshold according to a designated computation method. The control computing unit performs a following determination procedure of:

a) capturing the at least one activation threshold and the prize money values;

b) comparing the prize money values with the at least one activation threshold, and generating an activation signal when at least one of the prize money values corresponds to the at least one activation threshold; and

c) transmitting the activation signal to the prize money server device to cause the prize money award of the prize money value corresponding to the at least one activation threshold to be in a triggerable state.

Accordingly, the present invention first generates an activation threshold according to a betting selection of a player, and causes a prize money award of a prize money value corresponding to the activation threshold to be in a triggerable state. In other words, for a high roller placing large betting amounts, prize money awards in smaller amounts are not activated, and such prize money awards in small amounts that are not looked forward to by the player cannot be won, thus maintaining the playing rhythm of the player, and ensuring that the expectation of the player is satisfied without affecting the playing interest of the player when the prize money award is won.

### BRIEF DESCRIPTION OF THE DRAWINGS

FIG. 1 is a system structure diagram according to a first embodiment of the present invention;

FIG. 2 is a schematic diagram of a gaining machine according to the first embodiment of the present invention;

FIG. 3 is a schematic diagram of a game image according to the first embodiment of the present invention

FIG. 4 is a schematic diagram of a display image of prize money awards according to the first embodiment of the present invention;

FIG. 5 is a first schematic diagram of a betting selection of a way game in an implementation according to the first embodiment of the present invention;

FIG. 6 is a second schematic diagram of a betting selection of a way game in an implementation according to the first embodiment of the present invention;

FIG. 7 is a first schematic diagram of a betting selection of a line game in an implementation according to the first embodiment of the present invention;

FIG. 8 is a second schematic diagram of a betting selection of a line game in an implementation according to the first embodiment of the present invention;

FIG. 9 is a system structure diagram according to a second embodiment of the present invention; and

FIG. 10 is a system structure diagram according to a third embodiment of the present invention

### DETAILED DESCRIPTION OF THE PREFERRED EMBODIMENTS

Details and technical contents of the present invention are given with the accompanying drawings below.

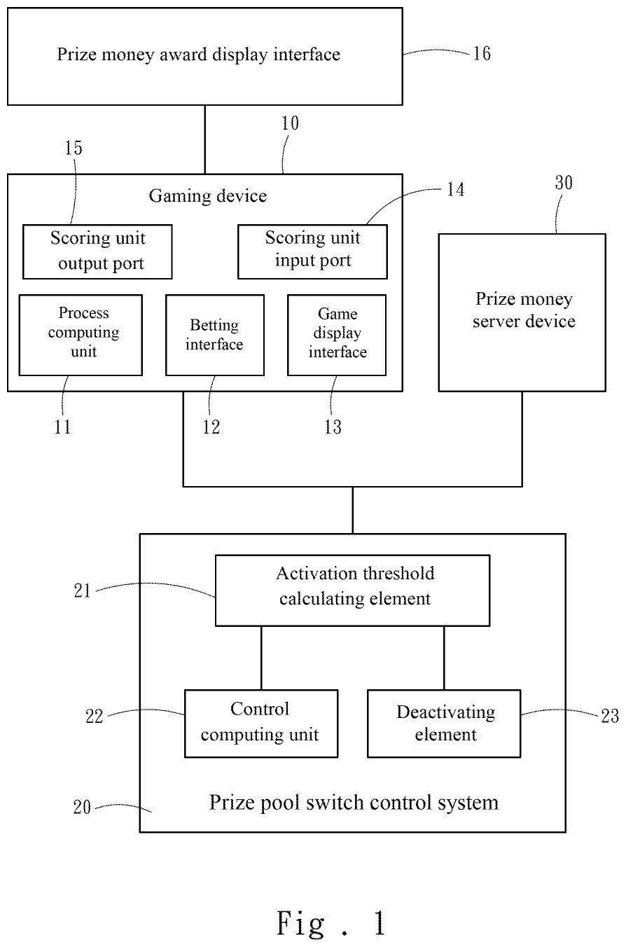

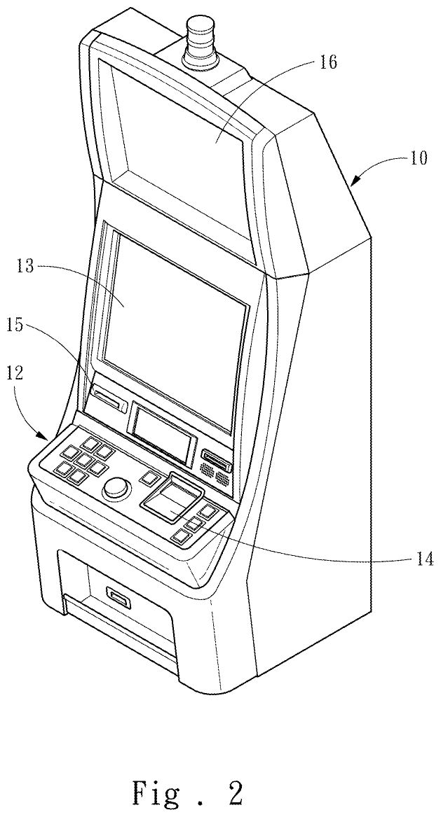

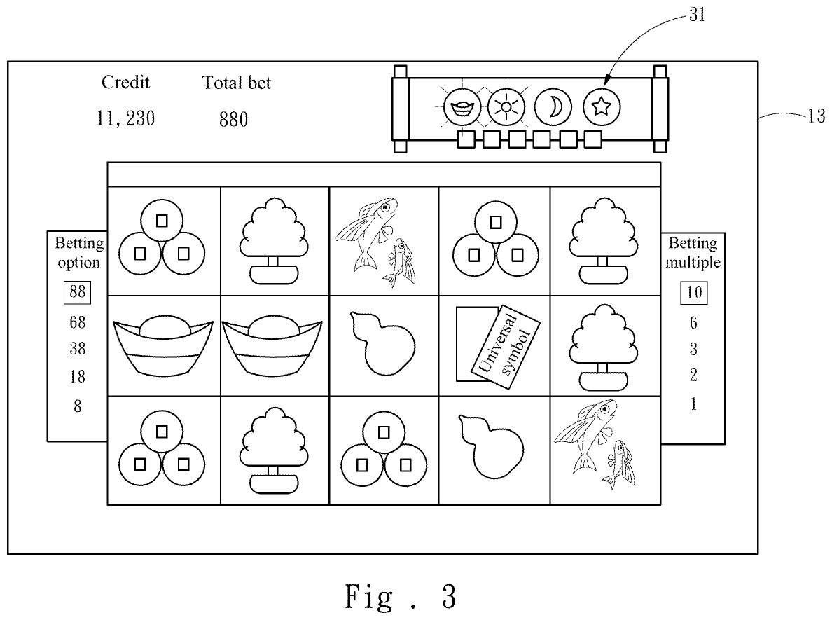

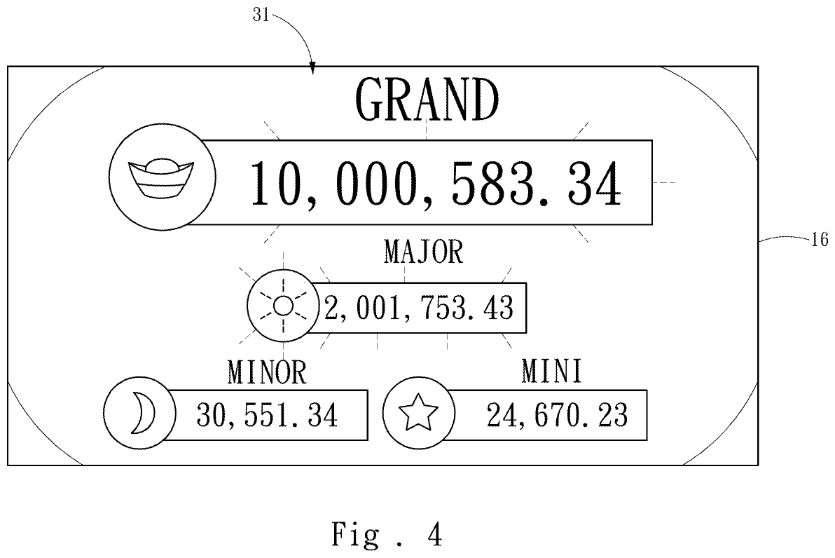

FIG. 1, FIG. 2, FIG. 3 and FIG. 4 show a prize pool switch control system 20 according to a first embodiment of the present invention. Referring to FIG. 1, FIG. 2, FIG. 3 and FIG. 4, the prize pool switch control system 20 is connected to a gaining device 10 and a prize money server device 30. The gaining device 10 includes a process computing unit 11, a betting interface 12, a game display interface 13, a scoring unit input port 14 and a scoring unit output port 15. The process computing unit 11 generates a plurality of game results. The betting interface 12 is operable by a player to generate a betting selection. In practice, the betting interface 12 may be a press key or a touchscreen. The game display interface 13 is a display screen for displaying the game results. Further, the game display interface 13 may also be integrated with the betting interface 12 into one body, so as to allow a player to place a bet on a touch display screen and observe game results. The scoring unit input port 14 is used for a player to place in money notes or tokens, which are then converted into an amount or credits for a player to play games. When a player wishes to stop playing the game, remaining money notes or tokens may be retrieved from the scoring unit output port 15.

When a player wishes to play a game, money notes or tokens are placed in through the scoring unit input port 14 to obtain an amount or credits required for game playing. The game display interface 13 is capable of displaying a plurality of different betting selections for the player to choose from on the betting interface 12 for game playing. While game results are generated, the process computing unit 11 randomly selects from the game results and displays the selected game result on the game display interface 13, and at the same time determines whether to make a payout to the player according to the game result. In addition to the payout from the game result, the player may also trigger, according to a predetermined symbol appearing in the game result or the game result satisfying a predetermined rule, a prize money game to further win prize money. Details associated with the prize money are to be given below.

The prize money server device 30 stores a plurality of prize money values corresponding to a plurality of prize money awards 31. As shown in FIG. 4, for example, the prize money awards 31 include mini, minor, major and grand prizes.

The prize pool switch control system 20 includes an activation threshold calculating element 21, a control computing unit 22, and a deactivating element 23. The activation threshold calculating element 21 captures the betting selection placed by the player on the betting interface 12, and generates at least one activation threshold according to a designated computation method.

The control computing unit 22 performs a following determination process of:

a) capturing the at least one activation threshold and the prize money values;

b) comparing the prize money values with the at least one activation threshold, and generating an activation signal when at least one of the prize money values corresponds to the at least one activation threshold; and

c) transmitting the activation signal to the prize money server device 30 to cause the prize money award 31 of the prize money value corresponding to the at least one activation threshold to be in a triggerable state.

Whether the triggerable prize money awards 31 are to be paid out to the player can be determined according to currently played games. Thus, during the process of game playing, the player can randomly win basic payouts of game results, and is further entitled to a chance of winning a prize money award.

The determination procedure further includes: when the at least one of the prize money values does not correspond to the at least one activation signal, the control computing unit 22 controls the deactivating element 23 to generate a deactivation signal, and transmits the deactivation signal to the prize money server device 30, so as to keep the prize money award 31 of the at least one of the prize money values that does not correspond to the at least one activation signal to be in a deactivated state. Thus, when the prize money values do not correspond to the activation threshold, it is ensured that the prize money award 31 is kept in a deactivated state, hence ensuring that a high roller player betting a large amount is prevented from getting the prize money award 31 in a small amount. In other embodiments of the present invention, the prize pool switch control system 20 may include only an activation threshold calculating element 21 and a control computing unit 22, so as to eliminate the determination procedure that the control computing unit 22 controls the deactivating element 23 to generate a deactivation signal.

It should be noted that, each time the player changes the betting selection, the activation threshold calculating element 21 re-execute the foregoing determination procedure according to the designated computation method, and generates a changed activation threshold corresponding to the changed betting selection. Thus, the prize money award 31 that corresponds to the changed activation threshold can be caused to be in a triggerable state, and the prize money award 31 that does not correspond to the changed activation threshold is caused to be in a deactivated state and prevented from being won by the player.

The designated computation method of the activation threshold is determined according to an integrated computation of game characteristics, regional requirements, player expected amounts and the rule of thumb. A signal of a betting selection made by the player may be from betting options, betting multiples or a total bet. The activation threshold calculating element 21 uses the signal of the betting selection to form the activation signal by means of a function calculation conversion or a look-up table. The control computing unit 22 then compares the activation threshold with the prize money values of the plurality of prize money awards 31, and generates an activation signal for the corresponding one or more prize money awards 31 to notify the prize money server device 30, so as to cause the one or more corresponding prize money awards 31 to be in a triggerable state. Conversely, for one or more prize money awards 31 that do not correspond to the activation threshold, the control computing unit 22 notifies the deactivating element 23 to generate the deactivation signal, and the deactivation signal is transmitted to the prize money server device 30 to keep the one or more non-corresponding prize money awards 31 in a deactivated state.

Alternatively, the activation threshold calculating element 21 first performs calculation according to the betting selection to obtain a betting amount, and directly multiplies the betting amount by a predetermined multiple to determine the activation threshold for activation and deactivation. For example, the activation threshold calculating element 21 may directly set twice the betting amount as the activation threshold. When the control computing unit 22 determines that a start-up prize money value of the prize money value is greater than twice the betting amount, the control computing unit 22 transmits the activation signal to the prize money server device 30 to activate the prize money award 31 corresponding to the prize money value, so as to cause this prize money award 31 to be in a triggerable state. On the other hand, if the control computing unit 22 determines that the prize money value is smaller than twice the betting amount, the control computing unit 22 controls the deactivating element 23 to generate the deactivation signal to deactivate the prize money award 31 corresponding to the prize money value, so as to cause this prize money award 31 to be in a non-triggerable state. The multiple “twice” of the betting amount is given as an example, and the multiple may be set to 1.3 times, 3 times or 5 times. Preferably, the multiple may be determined according to expected values of players and profit goals of gaining facilities in various regions.

In practice, the betting selection includes a betting option, a betting multiple and a total bet (BET). The betting option may be applied to a way game or a line game. With respect to a way frame, as shown by the game display interface 13 in FIG. 3, the game provides all reels/ways, i.e., 243 ways (3 raised to the power of 5, i.e., 3⁵), and the left side provides five betting options, which are respectively 8, 18, 38, 68 and 88. The player, by selecting different betting options, can correspondingly activate or deactivate the prize pool having different awards, e.g., mini, minor, major and grand prizes. Further, the right side of the game display interface 13 provides betting multiples, which are five multiple options including 1, 2, 3, 6 and 10. The total bet is calculated as, the betting option selected by the player from the five betting options including 8, 18, 38, 68 and 88 multiplied by the betting multiple selected by the player from the five betting multiple including 1, 2, 3, 6 and 10. As shown by the example in FIG. 3, the player has selected the betting option 88 (marked by a selection frame) and the betting multiple of 10 (marked by a selection frame), and so the total bet is 88 on the left multiplied by 10 on the right, i.e., 880 shown in the diagram.

Referring to FIG. 4, the gaining device 10 may be further connected to a prize money award display interface 16. In practice, the gaining device 10, in addition to the foregoing game display interface 13 (i.e., the display screen), is further connected to an additional display screen independent from the gaining device, i.e., the prize money award display interface 16. The gaining device 10 obtains the prize money values of the prize money awards 31 from the prize money server device 30 and the prize money awards 31 in the triggerable state, and transmits the same to the prize money award display interface 16. The prize money awards 31 are displayed on the prize money award display interface 16, and the prize money award 31 in the triggerable state is displayed in emphasis

Again referring to FIG. 3, in another embodiment, the prize money awards 31 may be directly displayed on the game display interface 13, allowing the game result and the prize money awards 31 to be simultaneously displayed on the same display screen. Alternatively, the gaining device 10 has two screens at the same time, which respectively display the game result and the prize money awards 31. Regardless of whether the game display interface 13 is a single-display screen or a dual-display screen, the prize money award 31 in the triggerable state is emphasized to attract the attention of the player.

In the examples in FIG. 3 and FIG. 4, the prize money award 31 in the triggerable state includes only the major and grand prizes. There are numerous ways for implementing emphasized display. For example, the triggerable prize money award 31 is displayed by a higher brightness level. Alternatively, brightness levels are modified, i.e., the activated prize money award 31 is displayed by a higher brightness level, whereas the non-activated prize money award 31 appears darker. Alternatively, a symbol such as a cross, a chain or a lock is added to the deactivated prize money award 31, or only the activated prize money award 31 is enlarged and displayed. The above means for implementing emphasized display are only examples, and do not form limitations to actual applications of the present invention.

Based on the above, the present invention is capable of selectively activating or deactivating the prize money award 31 according to the betting selection. In other words, when the betting amount is high, the prize money award 31 in a small amount is deactivated and thus prevented from being triggered by the player and from affecting the playing rhythm. The example below corresponds to the betting selection in FIG. 3, with the betting options including 8, 18, 38, 68 and 88, and the corresponding prize money awards 31 including mini, minor, major and grand prizes. By using the prize pool switch control system of the present invention, different betting options are computed and determined, and the prize money awards 31 can be correspondingly activated or deactivated. For example, when the betting option is 8, only the mini prize is activated; when the betting option is 18, the mini and minor prizes are activated; when the betting option is 38, the minor and major prizes are activated; when the betting option is 68, the major and grand prizes are activated; when the betting option is 88, only the grand prizes is activated. The activation and deactivation of the prize money awards 31 may be correspondingly have other implementations, and can be configured depending on actual requirements.

The control computing unit 22 is capable of performing the determination procedure independently on the prize money values. Because each betting selection may correspond to more than one prize money value, the control computing unit 22 needs to perform the determination procedure individually on the selected betting selection. The above individual determination procedure may appear complicated, it is however generally known that programs can be executed extremely fast, thus allowing the game display interface 13 to directly display the activated or deactivated prize money award 31 when the user changes the betting selection.

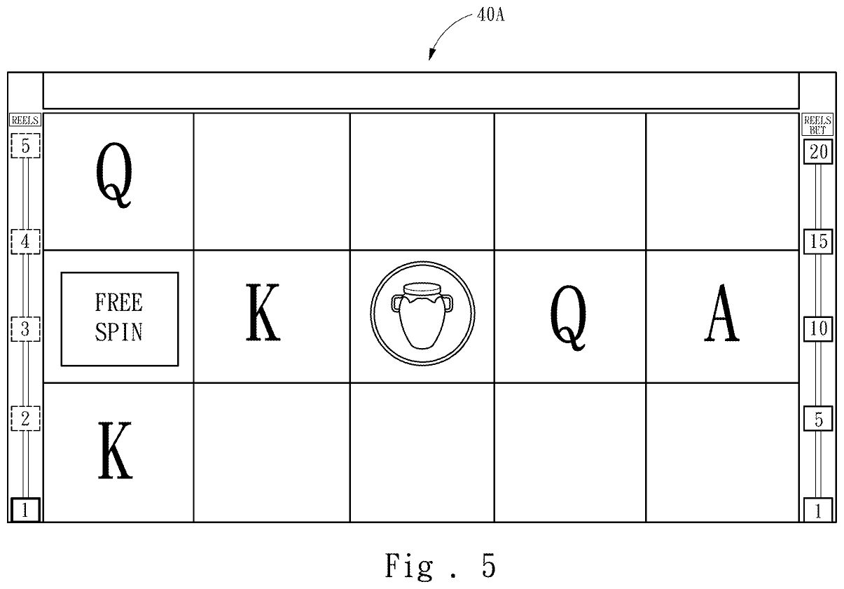

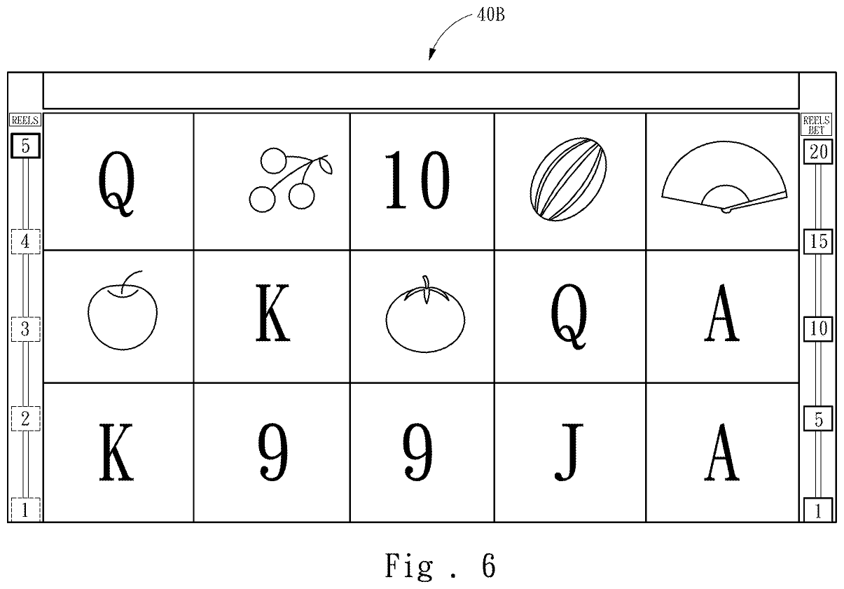

Referring to FIG. 5 and FIG. 6, game images 40A and 40B are for illustrating a design of applying the first embodiment to a way game, in which different numbers of reels are activated to allow a player to switch among different betting options to provide different numbers of reels and ways for game playing. For example, only one reel in FIG. 5 is activated (the frames in thick lines around the numbers of “REEL” on the left indicates an activated state, whereas the frames in dotted lines indicate a deactivated state), and all of the five reels in FIG. 6 are activated. Thus, with different numbers of reels activated, a player is required to place different betting amounts or credits, and the betting amounts or credits are not necessarily changed by the same multiple according to different numbers of activated reels. As the way game in FIG. 5 and FIG. 6, when a player selects different numbers of activated reels, the prize money awards of different prize money value may be correspondingly activated or deactivated. For example, in FIG. 5, the number of activated reels is less, and so only the prize money awards 31 for mini and minor prizes can be activated. That is to say, after the activation threshold calculating element 21 captures the betting selection of only one activated reel, and generates at least one activation threshold according to the designated computation method, the control computing unit 22 performs the determination procedure to cause the prize money server device 30 to activate only the two prize money awards 31 of the corresponding mini and minor prizes. Referring to FIG. 6, all of the reels are activated, and so the prize money awards 31 of the mini and minor prizes are deactivated and the prize money awards 31 of the major and grand prizes are activated. That is, after the activation threshold calculating element 21 captures the betting selection of all of the five reels activated by the player and generates at least one activation threshold according to the designated computation method, the control computing unit 22 performs the determination procedure to cause the prize money server device 30 to, in response to the activation and deactivation signals received, deactivate the prize money awards 31 of the mini and minor prizes and at the same time activate the prize money awards 31 of the major and grand prizes.

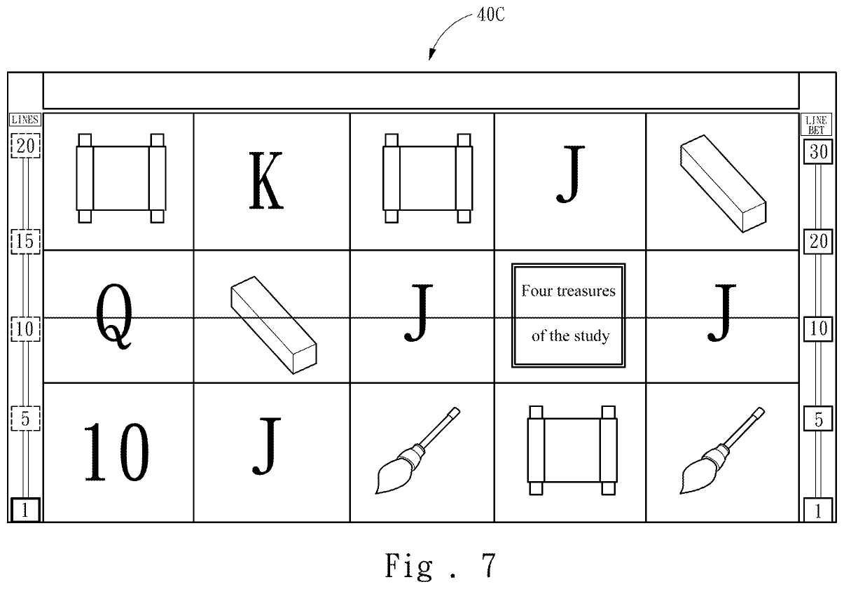

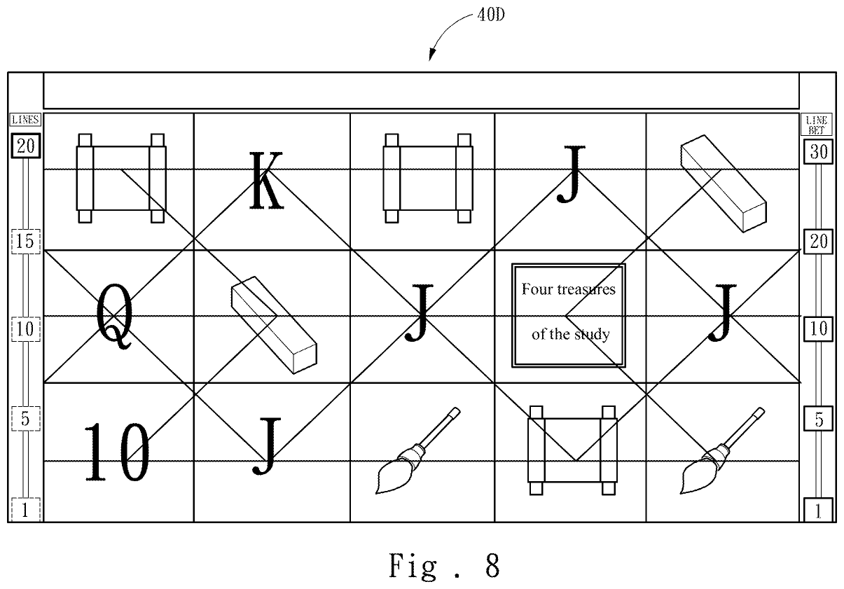

Referring to FIG. 7 and FIG. 8, game images 40C and 40D are for illustrating a design of the first embodiment applied to a line game. As shown in FIG. 7, the player at this point has selected only one line set by the game (frames in thick lines around the numbers for LINE on the left indicate an activated state, and frames in dotted lines indicate a deactivated state). As shown in FIG. 8, the player at this point has selected 20 predetermined lines set by the game. The lines are shown in FIG. 7 and FIG. 8 only temporarily appear when the player selects the lines to be betted on. Thus, the player selects, from the 20 predetermined lines, the lines to be bet on (i.e., selecting the betting options to be betted on), and the prize money awards 31 of different prize money values are correspondingly activated or deactivated according to the number of lines selected and betted by the player. For example, as shown in FIG. 7, when the player has selected “1” on the bottom to bet on only one line, only the prize money award 31 of the mini prize is activated. That is to say, after the activation threshold calculating element 21 captures the betting selection of betting on only one line and generates at least one activation threshold according to the designated computation method, the control computing unit 22 performs the determination procedure to cause the prize money server device 30 to activate the prize money award 31 corresponding to the mini prize. As shown in FIG. 8, when the player has selected “20” on the top to bet on twenty lines, the prize money awards 31 of the mini and minor prizes are deactivated, and the prize money awards 31 of the major and grand prizes are at the same time activated. That is to say, after the activation threshold calculating element 21 captures all of the betting selection of twenty lines betted by the player and generates at least one activation threshold according to the designated computation method, the control computing unit 22 performs the determination procedure to cause the prize money server device 30 to, in response to the activation and deactivation signals received, deactivate the prize money awards 31 of the mini and minor prizes and at the same time activate the prize money awards 31 of the major and grand prizes.

Further, as previously described, each of the game results of the present invention may have a basic payout value, and the activation threshold calculating element 21 may generate the at least one activation threshold on the basis of the betting selection and the payout values according to the designated computation method. Because different betting selections (betting options, betting multiples and the total bet) may result in different payout values for the game result, denomination conversion is performed on the payout value to obtain a payout amount. According to a common probability design result of games, the payout amount most frequently given to a player is 0 (not winning any prize), and other payout amounts having lower probabilities are, for example, 0.05 to 2430 times of the betting amount. In other words, in most situations, the payout amount is the betting amount multiplied by a multiple of smaller than 1 or 0 (not winning any prize). Take one kind of way games as an example, the way game has five reels, each of the five reels randomly selects and displays three consecutive symbols and the total bet is 500, wherein the game is set with a rule that when one particular symbol appearing at all of the five reels, the payout value is 5000; when the symbol appears in a quantity of three at all of the five reels, the payout value is 3⁵ times of the former payout value 5000, which is 5000×243. That is, the latter payout value is 2430 times of the total bet (5000×243/500), which is equal to the foregoing 2430 times of the betting amount. It should be noted that, the above example is given in terms of credits but not an actual monetary amount, and the multiple stays the same after a denomination conversion is performed on the credits. A reason for the above is that, different games are designed with different ranges of multiples of payout amounts. For example, for some games, no credits are won in most cases, with however some game results of specific multiples appearing more frequently than others. For example, the second highest probability of a game result appearing in game A is 1.5 times, and the second highest probability of the game result in game B is 3. Theoretically, the probability of the latter is lower than the former; that is, for the second highest probability in two different games, the probability of a higher multiple is lower than the probability of a lower multiple.

Based on the above description, in an implementation according to the first embodiment of the present invention, the designated computation method used by the activation threshold calculating element 21 is first determining the betting selection of the player, with reference to payout values of various current game results and payout amounts obtained after the denomination conversion. Next, the betting amount of the current betting selection is determined, a player payback rate and various game results of this machine are captured, and calculation is performed to obtain probabilities of the various payout amounts. After excluding the payout amount of 0, from multiples having the 2^{nd} to 5^{th} highest probabilities, one, two or three are selected and averaged, and the average value is multiplied by the betting amount to obtain a product as the activation threshold. When the control computing unit 22 determines that the start-up prize money value is larger than the threshold, the activation signal is generated and transmitted to the prize money server device 30 to activate the prize money award 31 corresponding to the prize money value to be in a triggerable state. On the other hand, if the control computing unit 22 determines that the start-up prize money value of the prize money is smaller than the activation threshold, the control computing unit 22 controls the deactivating element 23 to generate a deactivation signal and to transmit the deactivation signal to the prize money server device 30, so as to deactivate the prize money award 31 corresponding to this prize money value and to cause this the prize money award 31 to be in a non-triggerable state.

In another implementation according to the first embodiment of the present invention, the designated computation method may calculate an average payout amount according to the prize money values, at least one of a plurality of game result probabilities of the game results and at least one of a plurality of payout values corresponding to the game result probabilities, and multiply the average payout amount by a multiple to generate the at least one activation threshold.

More specifically, in one approach of this implementation, the designated computation method is that, the activation threshold calculating element 21 calculates an average payout amount according to the probability of the game result, the corresponding payout value and denomination of the game result, and multiplies the average payout amount by a multiple as the activation threshold. The control computing unit 22 then compares this activation threshold with the prize money values. The multiple by which the average payout amount is multiplied may be 1, greater than 1 or smaller than 1, depending on actual requirements. Further, the activation threshold calculating element 21 may also consider probabilities of specific game results and the corresponding payout values, and calculate the average payout amount according to the denomination. The so-called specific game results are, for example, three largest payout values, or payout values of alternating rankings, i.e., odd-number payout values, such as those ranking at top 1^{st}, 3^{rd} and 5^{th} places.

It is known from the above description that, in the designated computation method used by the prize pool switch control system 20 of the present invention, parameter values of start-up prize money values, increment ratios, probabilities of game results, and payout values corresponding to game results may be adjusted in response to preferences of players in different countries and regions.

The prize pool switch control system 20 may further include an activation threshold data list, and each prize money award 31 is provided with an increment ratio. The activation threshold calculating element 21 multiplies the betting selection by the increment ratios according to the designated computation method to accordingly generate from the activation threshold data list the at least one activation threshold. Alternatively, in another implementation, the activation threshold calculating element 21 multiples the betting selection by the increment ratios according to the designated computation method, and further multiplies by an adjustment magnification ratio to generate the at least one activation threshold.

That is to say, the process computing unit 11 calculates the total bet each time for each betting selection of the player, converts the total bet by denomination conversion to a betting amount, and then multiplies the total bet by an increment ratio to distribute and add the result to the various prize money awards 31. The increment ratio may differ in response to different betting options and betting multiples. The activation threshold calculating element 21 may acquire the corresponding increment ratio for each betting selection of the player, and directly use the increment ratio as the activation threshold according to the increment ratio, or convert into a distributed amount as the activation threshold.

A detailed calculation example is given below. The betting selection is set as the betting multiple, which includes 10, 20, 40, 70 and 90, and the prize money award 31 in a triggerable state can be changed (i.e., activated or deactivated) by selecting different betting multiples. Assume that in this example, five prize money awards 31 are, in a decreasing order, grand, maxi, major, minor and mini prizes, and the increment ratios of the respective betting amounts corresponding to the prize money awards 31 are 0.01, 0.05, 0.1, 0.2 and 0.25 (which are examples rather than actual settings). Thus, the corresponding relationship between the betting multiple and the increment ratio is shown in the table below:

| | 10 | 20 | 40 | 70 | 90 |
|---|---|---|---|---|---|
| 0.01 | 0.1 | 0.2 | 0.4 | 0.7 | 0.9 |
| 0.05 | 0.5 | 1 | 2 | 3.5 | 4.5 |
| 0.1 | 1 | 2 | 4 | 7 | 9 |
| 0.2 | 2 | 4 | 8 | 14 | 18 |
| 0.25 | 2.5 | 5 | 10 | 17.5 | 22.5 |
| SUM | 6.1 | 12.2 | 24.4 | 42.7 | 54.9 |

Thus, the following configuration may be designed. When the activation threshold calculating element 21 calculates that the total amount (SUM) incremented by the current betting selection is 6.1, after the control computing unit 22 performs the determination procedure, the prize money server device 30, in response to the activation signal or at the same time in response to the deactivation signal, activates only the mini prize to be in a triggerable state and deactivates others to a non-triggerable state. When the activation threshold calculating element 21 calculates that the total amount incremented by the current betting selection is 12.2, after the control computing unit 22 performs the determination procedure, the prize money server device 30, in response to the activation signal or at the same time in response to the deactivation signal, activates only the minor prize to be in a triggerable state and deactivates others to a non-triggerable state. When the activation threshold calculating element 21 calculates that the total amount incremented by the current betting selection is 24.4, after the control computing unit 22 performs the determination procedure, the prize money server device 30, in response to the activation signal or at the same time in response to the deactivation signal, activates only the major prize to be in a triggerable state and deactivates others to a non-triggerable state. When the activation threshold calculating element 21 calculates that the total amount incremented by the current betting selection is 42.7, after the control computing unit 22 performs the determination procedure, the prize money server device 30, in response to the activation signal or at the same time in response to the deactivation signal, activates only the maxi prize to be in a triggerable state and deactivates others to a non-triggerable state. When the activation threshold calculating element 21 calculates that the total amount incremented by the current betting selection is 54.9, after the control computing unit 22 performs the determination procedure, the prize money server device 30, in response to the activation signal or at the same time in response to the deactivation signal, activates only the grand prize to be in a triggerable state and deactivates others to a non-triggerable state.

Another configuration design is given below. When the activation threshold calculating element 21 calculates that the total amount incremented is 6.1, after the control computing unit 22 performs the determination procedure, the prize money server device 30, in response to the activation signal or at the same time in response to the deactivation signal, keeps all of the prize money awards 31 deactivated and non-triggerable. When the activation threshold calculating element 21 calculates that the total amount incremented by the current betting selection is 12.2, after the control computing unit 22 performs the determination procedure, the prize money server device 30, in response to the activation signal or at the same time in response to the deactivation signal, activates the mini prize to be in a triggerable state. When the activation threshold calculating element 21 calculates that the total amount incremented by the current betting selection is 24.4, after the control computing unit 22 performs the determination procedure, the prize money server device 30, in response to the activation signal or at the same time in response to the deactivation signal, simultaneously activates the mini and major prizes to be in a triggerable state. When the activation threshold calculating element 21 calculates that the total amount incremented by the current betting selection is 42.7, after the control computing unit 22 performs the determination procedure, the prize money server device 30, in response to the activation signal or at the same time in response to the deactivation signal, deactivates the mini and major prizes and activates the minor and maxi prizes to be in a triggerable state. When the activation threshold calculating element 21 calculates that the total amount incremented by the current betting selection is 54.9, after the control computing unit 22 performs the determination procedure, the prize money server device 30, in response to the activation signal or at the same time in response to the deactivation signal, further activates the grand prize to be in a triggerable state in addition to keeping the minor and maxi prizes activated.

The incremented amount of each bet of the player is set as a prize money increment value. The activation threshold calculating element 21 calculates in advance for each prize money award 31 an amount to be correspondingly incremented as the activation threshold. Thus, the prize money increment value incremented by each bet of the player may have different possibilities in response to different betting selections. The activation threshold calculating element 21 compares the prize money increment value with a predetermined activation threshold. Thus, the prize money server device 30 may determine, according to the activation signal sent by the activation threshold calculating element 21, or even with reference to the deactivation signal generated by the deactivating element 23, to activate or deactivate the corresponding prize money award 31. To facilitate the comparison, the increment amounts to be set and used for determining whether to activate or deactivate the prize money awards 31 are collected in a set to form the activation threshold data list. The activation threshold calculating element 21 may multiply the prize money increment values, to be set and for determining whether to activate or deactivate the prize money awards 31, by a multiple to serve as the activation threshold.

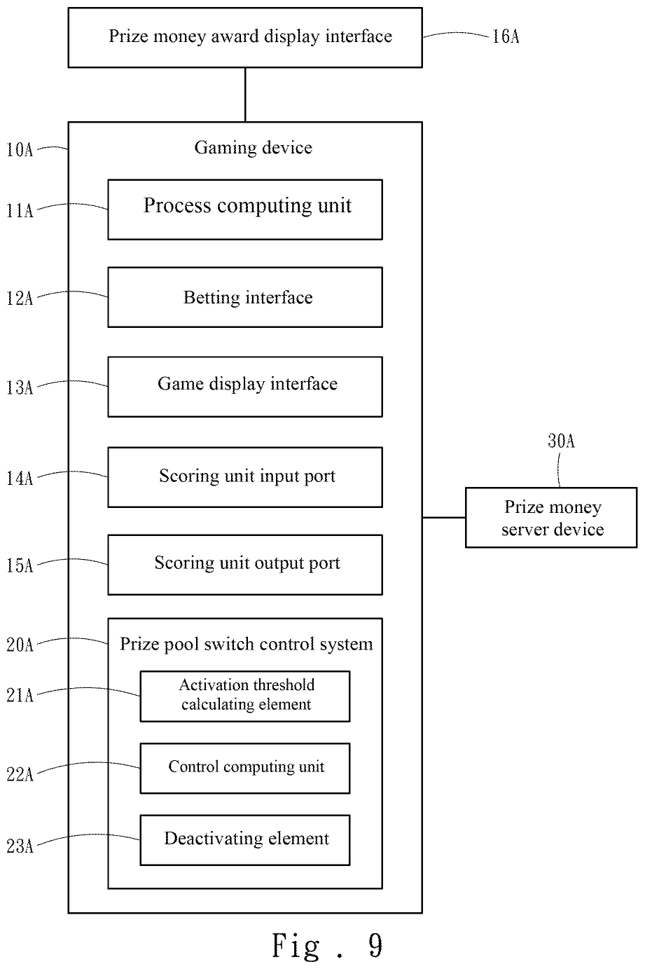

FIG. 9 shows an implementation according to a second embodiment of the present invention. In this embodiment, a gaining device 10A includes a process computing unit 11A, a betting interface 12A, a game display interface 13A and a prize poll switch control system 20A. That is, some main differences of this embodiment from the previous embodiment are that the prize poll switch control system 20A is a part of the gaining device 10A, and the gaining device 10A is directly connected to a prize money server device 30A and a prize money award display interface 16A. Operation details of the components in this embodiment are substantially identical to those in the first embodiment, and the implementations of the first embodiment are also applicable to this embodiment. Further, for example but not limited to, the gaining device 10A further includes a scoring unit input port 14A and a scoring unit output port 15A, the prize pool switch control system 20A further includes an activation threshold calculating element 21A, a control computing unit 22A and a deactivating element 23A, the game display interface 13A may be integrated with the betting interface 12A into one body, and the gaining device 10A may be further connected to an additional display screen independent from the gaining device. There are numerous other modifications, which shall be omitted herein.

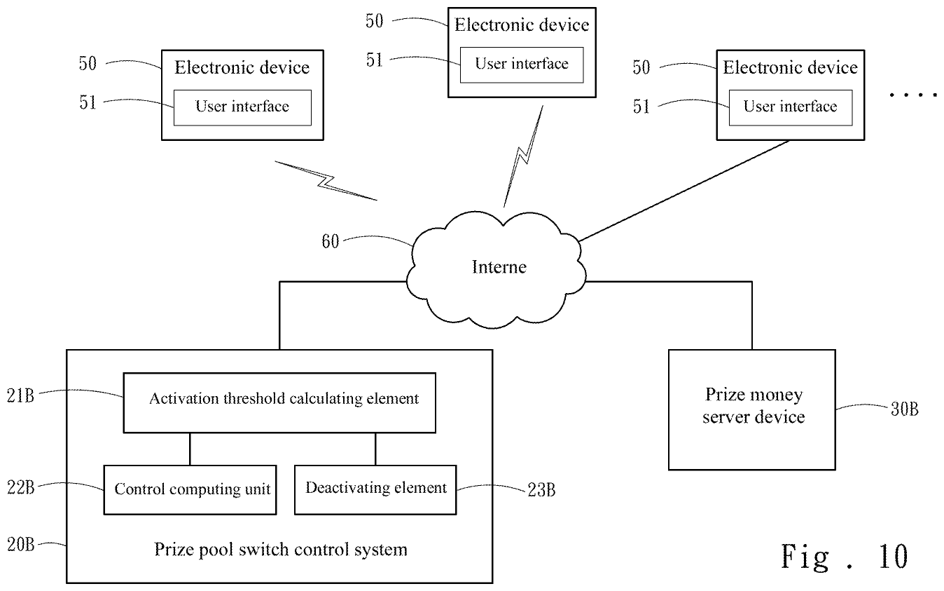

FIG. 10 shows a third embodiment of the present invention. In this embodiment, the prize pool switch control system 20B is applied to an electronic device 50 such as a personal computer, a touch cell phone, a tablet computer, an augmented reality (AR) device or a virtual reality (VR) device. A plurality of players at a remote end may connect the above electronic devices 50 through a connection (which may be a wireless or wired connection) of the Internet 60 to the prize pool switch control system 20B and a prize money server device 30B, and play games by operating a user interface 51 in each of the electronic devices 50. The user interface 51 provides the player with betting and selection buttons for the player to click select and display a click selected item. The electronic device 50 is connected from a remote end to the prize pool switch control system 20B and the prize money server device 30B. In other words, the electronic device 50 acts as a gaining device of the present invention.

An actual implementation of the third embodiment of the present invention is as described below. The prize pool switch control system 20B is connected through the Internet 60 to the electronic device 50 and the prize money server device 30B. The electronic device 50 includes a process computing unit, a betting interface and a game display interface. Further, according to the type of the electronic device 50, the electronic device 50 may have different user interfaces 51. For example, when the electronic device 50 is a touch cell phone, the user interface 51 may be a touch screen, which forms the betting interface and the game display interface; that is, the betting interface and the game display interface are integrated on the touch screen of the touch cell phone. The electronic device 50 generates a plurality of game results through the process computing unit, the betting interface is operable by the player to generate a betting selection, the game display interface displays the game results, and the prize money server device 30B stores a plurality of prize money values corresponding to a plurality of prize money awards.

The prize poll switch control system 20B includes an activation threshold calculating element 21B, a control computing unit 22B and a deactivating element 23B. The activation threshold calculating element 21B captures the betting selection placed by the player on the betting interface, and generates at least one activation threshold according to a designated calculation method. The control computing unit 22B performs a determination procedure of:

a) capturing the at least one activation threshold and the prize money values;

b) comparing the prize money values with the at least one activation threshold, and generating an activation signal when at least one of the prize money values corresponds to the at least one activation threshold; and

c) transmitting the activation signal to the prize money server device 30B to cause the prize money award of the prize money value corresponding to the at least one activation threshold to be in a triggerable state.

Similarly, to ensure that the prize money awards stay in a deactivated state, the determination procedure may include another step of: when at least one of the prize money values does not correspond to the at least one activation threshold, controlling the deactivating element 23B to generate a deactivation signal, and transmitting the deactivation signal to the prize money server device 30B to cause the prize money award of the at least one of the prize money values in which none corresponds to the least one activation threshold to be in a deactivated state.

According to the foregoing structure of the third embodiment, the convenience brought by the Internet without boundaries can be fully exercised, thus increasing the willingness of players for playing. It should be noted that, in other implementations of the embodiment, the prize pool switch control system 20B and the prize money server device 30B may also be connected to transmit signals through, in addition to the foregoing wireless network and network communication, a physical line.

It should be noted that, the first embodiment is illustrated by taking a way game or a line game of a slot machine as example. However, a person skilled in the art could easily conceive of applying the present invention to other gaining devices providing players with prize money awards, for example but not limited to, dice gaining devices, poker game devices, roulettes game devices and bingo game devices. Further, the betting selection of the present invention may include multiple selections. The term “multiple selections” is that, for example, a player is allowed to perform a multi-selection operation on a betting interface of a slot machine, or choose multiple reels on a betting interface for a way game. More specifically, for example, in a 3×5 way game, a player can simultaneously choose betting options of 3×1×3×2×1=18 reels; in a line game, a player can simultaneously choose multiple lines on a betting interface, for example but not limited to, in a line game having predetermined 20 lines set by the game, simultaneously betting on 7 line betting options including 1^{st}, 6^{th} to 8^{th} and 16^{th} to 18^{th} lines. For both way games and line games, a player is allowed to select a plurality of multiples on a betting interface according to personal preferences, for example but not limited to, simultaneously betting on betting multiples including 1 time, 5 times, 20 times and 26 times from betting multiples of 1 time, 5 times, 10 times, 15 times and 20 times.

For a dice gaining device such as Sic Bo, a player may simultaneously bet on a plurality of selections on a betting interface, for example but not limited to, simultaneously betting on “small” and “total point of 8”. For a poker gaining device such as baccarat, a player may simultaneously bet on multiple selections on a betting interface, for example but not limited to, simultaneously betting on “house wins” and “house has a pair”. For a roulette gaining device, a player may simultaneously bet on a plurality of selections on a betting interface, for example but not limited to, simultaneously betting on 0, 1, 2, 3 and red. For a bingo gaining device, a player may simultaneously bet on a plurality of bingo cards, or placing different bets on different bingo cards.

Based on the foregoing multiple betting selections, the prize pool switch control device regards these betting selections as one single selection and processes accordingly. Alternatively, the multiple selections in the betting selections are processed individually. More specifically, in the prize poll switch control system of the latter, the activation threshold calculating element captures the multiple selections of the betting selections placed on the betting interface, and respectively generates a plurality of corresponding activation thresholds for these selections according to the designated calculation method. The control computing unit then performs the determination procedure for each of the activation thresholds and the corresponding prize money award.

In conclusion, in the present invention, an activation threshold is first generated according to a betting selection of a player, and a prize money award of a prize money value corresponding to (greater than) the activation threshold is caused to be in a triggerable state, while a prize money award of a prize money value smaller than the activation threshold is deactivated. In other words, in the present invention, prize money awards of smaller prize money values are not activated and prize money awards not looked forward to by a player are not revealed, thus maintaining the playing rhythm of a player, and ensuring that the expectation of a player is satisfied without affecting playing interest of a player when a prize money award is revealed.

What is claimed is:

1. A prize pool switch control system, connected to a gaining device and a prize money server device, the gaining device comprising a process computing unit, a betting interface and a game display interface, the process computing unit generating a plurality of game results, the betting interface being operable by a player to generate a betting selection, the game display interface displaying the plurality of game results, the prize money server device storing a plurality of prize money values corresponding to a plurality of prize money awards; the prize pool switch control system comprising:
an activation threshold calculating element, capturing the betting selection bet by the player on the betting interface, and generates at least one activation threshold according to a designated computation method; and
a control computing unit, performing a determination procedure of:
a) capturing the at least one activation threshold and the plurality of prize money values;
b) comparing the plurality of prize money values with the at least one activation threshold, and generating an activation signal when at least one of the prize money values corresponds to the at least one activation threshold; and
c) transmitting the activation signal to the prize money server device to cause the prize money award of the prize money value corresponding to the at least one activation threshold to be in a triggerable state.

2. The prize pool switch control system of claim 1, further comprising a deactivating element, wherein the determination procedure further comprises: when at least one of the plurality of prize money values does not correspond to the at least one activation threshold, controlling the deactivating element to generate a deactivation signal, and transmitting the deactivation signal to the prize money server device to cause the prize money award of the at least one of the plurality of prize money values that does not correspond to the at least one activation threshold to be in a deactivated state.

3. The prize pool switch control system of claim 1, wherein the gaining device is further connected to the prize money server device and a prize money award display interface; the gaining device acquires the plurality of prize money values of the plurality of prize money awards and the prize money award in the triggerable state from the prize money server device, and transmits the same to the prize money award display interface, to cause the plurality of prize money awards to be displayed on the prize money award display interface and the prize money award in the triggerable state to be displayed in emphasis.

4. The prize pool switch control system of claim 1, wherein the gaining device is further connected to the prize money server device to acquire the plurality of prize money values of the plurality of prize money awards and the prize money award in the triggerable state, the plurality of prize money awards are displayed on the prize money award display interface, and the prize money award in the triggerable state is displayed in emphasis.

5. The prize pool switch control system of claim 1, wherein the control computing unit independently performs the determination procedure on the plurality of prize money values, respectively.

6. The prize pool switch control system of claim 1, wherein the betting selection is a betting option, a betting multiple or a total bet.

7. The prize pool switch control system of claim 1, wherein each of the plurality of game results has a payout amount, and the activation threshold calculating element generates the at least one activation threshold based on the betting selection and the plurality of payout amounts according to the designated computation method.

8. The prize pool switch control system of claim 7, wherein the designated computation method is that, the activation threshold calculating element calculates an average payout amount according to the plurality of prize money values, at least one of a plurality of game result probabilities of the plurality of game results and at least one of a plurality of payout values corresponding to the plurality of game result probabilities, and multiplies the average payout amount by a multiple to generate the at least one activation threshold.

9. The prize pool switch control system of claim 1, further comprising an activation threshold data list, wherein each of the plurality of prize money awards has an increment ratio, and the activation threshold calculating element multiplies the betting selection by the plurality of increment ratios according to the designated computation method to accordingly generate the at least one activation threshold from the activation threshold data list.

10. The prize pool switch control system of claim 1, wherein each of the prize money awards has an increment ratio, and the activation threshold calculating element multiplies the betting selection by the plurality of increment ratios according to the designated computation method and then multiplies by an adjustment magnification ratio to generate the at least one activation threshold.

11. A gaining device, connected to a prize money server device, the prize money server device storing a plurality of prize money values corresponding to a plurality of prize money awards; the gaining device comprising:
a process computing unit, generating a plurality of game results;
a betting interface, operable by a player to generate a betting selection;
a game display interface, displaying the plurality of game results; and
a prize pool switch control system, comprising:
an activation threshold calculating element, capturing the betting selection placed by the player on the betting interface, and generating at least one activation threshold according to a designated computation method; and
a control computing unit, performing a determination procedure of:
a) capturing the at least one activation threshold and the plurality of prize money values;
b) comparing the plurality of prize money values with the at least one activation threshold, and generating an activation signal when at least one of the prize money values corresponds to the at least one activation threshold; and
c) transmitting the activation signal to the prize money server device to cause the prize money award of the prize money value corresponding to the at least one activation threshold to be in a triggerable state.

12. The gaining device according to claim 11, wherein the prize pool switch control system further comprises a deactivating element; the determination procedure further comprises: when at least one of the plurality of prize money values does not correspond to the at least one activation threshold, controlling the deactivating element to generate a deactivation signal, and transmitting the deactivation signal to the prize money server device to cause the prize money award of the at least one of the plurality of prize money values that does not correspond to the at least one activation threshold to be in a deactivated state.

13. The gaining device according to claim 11, further connected to a prize money award display interface; wherein, the gaining device acquires the plurality of prize money values of the plurality of prize money awards and the prize money award in the triggerable state from the prize money server device, and transmits the same to the prize money award display interface, to cause the plurality of prize money awards to be displayed on the prize money award display interface and the prize money award in the triggerable state to be displayed in emphasis.

14. The gaining device according to claim 11, wherein the gaining device is further connected to the prize money server device to acquire the plurality of prize money values of the plurality of prize money awards and the prize money award in the triggerable state, the plurality of prize money awards are displayed on the prize money award display interface, and the prize money award in the triggerable state is displayed in emphasis.

15. The gaining device according to claim 11, wherein the control computing unit independently performs the determination procedure on the plurality of prize money values, respectively.

16. The gaining device according to claim 11, wherein the betting selection is a betting option, a betting multiple or a total bet.

17. The gaining device according to claim 11, wherein each of the plurality of game results has a payout amount, and the activation threshold calculating element generates the at least one activation threshold based on the betting selection and the plurality of payout amounts according to the designated computation method.

18. The gaining device according to claim 17, wherein the designated computation method is that, the activation threshold calculating element calculates an average payout amount according to the plurality of prize money values, at least one of a plurality of game result probabilities of the plurality of game results and at least one of a plurality of payout values corresponding to the plurality of game result probabilities, and multiplies the average payout amount by a multiple to generate the at least one activation threshold.

19. The gaining device according to claim 11, wherein the prize pool switch control system further comprises an activation threshold data list, each of the plurality of prize money awards has an increment ratio, and the activation threshold calculating element multiplies the betting selection by the plurality of increment ratios according to the designated computation method to accordingly generate the at least one activation threshold from the activation threshold data list.

20. The gaining device according to claim 11, wherein each of the prize money awards has an increment ratio, and the activation threshold calculating element multiplies the betting selection by the plurality of increment ratios according to the designated computation method and then multiplies by an adjustment magnification ratio to generate the at least one activation threshold.
